(19) United States
(12) Patent Application Publication
(10) Pub. No.: US 2009/0166201 A1
(43) Pub. Date: Jul. 2, 2009

(54) INJECTION METHOD FOR MICROFLUIDIC CHIPS

(75) Inventors: Wei-Cheng Tian, Clifton Park, NY (US); Erin Jean Finehout, Clifton Park, NY (US); Li Zhu, Clifton Park, NY (US); Jun Xie, Niskayuna, NY (US); Shashi Thutupalli, Bangalore (IN)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 11/965,789

(22) Filed: Dec. 28, 2007

(51) Int. Cl. G01N 27/26; G01N 27/447

(52) U.S. Cl. 204/453; 204/604

(57) ABSTRACT

A microfluidic chip comprising a separation channel configured to receive a sieving matrix and a buffer and an injection channel in fluid communication with the separation channel. The injection channel is configured to receive a sample using a capillary force and a portion of the sample injects into the separation channel electro-kinetic force exerted on the sample.

### BACKGROUND

The invention relates generally to microfluidic chips and more specifically to injection methods for microfluidic chips.

Electrophoretic separation of bio-molecules is very important in modern biology and biotechnology applications such as DNA sequencing, protein analysis and genetic mapping. Electrophoresis is a process by which individual molecular species are separated in a conductive medium (such as a liquid solution or a cross-linked polymer) by applying an electric field. The charged molecules migrate through the medium and separate into distinct bands due to their mobility difference. The rates are influenced by factors such as a viscosity of the medium, a mass and charge of the molecules, and a strength and duration of the electric field.

An increase in a voltage gradient (V/cm) applied to the electrophoretic device results in a corresponding decrease in the time needed to perform the separation. However, increasing the voltage gradient is governed by certain constraints. For example, increasing the voltage gradient beyond a certain point may result in an increase in joule heating which would in turn alter the properties of the medium in which the molecules are being separated. The change of the medium properties leads to an increase in sample diffusion and thus degraded the separation resolution. In order to alleviate the above limitations, electrophoresis can be performed in a capillary or miniaturized channel. The large surface-area-to-volume ratio of the electrophoretic devices offers efficient dissipation of Joule heat, allowing higher electric field to be used, thus resulting in the shorter analysis time and better separation efficiency.

Microchips are small microfluidic devices that perform chemical and physical operations such as capillary electrophoresis with microscale sample volumes. These devices often have the benefits of fast reactions, rapid detection, small reagent consumption, ease of automation and simple transfer between reaction vessels. Microfluidic devices are commonly referred to as “lab-on-a-chip.”

In microchip electrophoresis, a sample is loaded in a sample reservoir and a voltage is applied between a sample reservoir and a waste reservoir to move sample into the loading channel. However, proteins with different mobilities may result in a biased injection, in which the sample injected into the separation channel does not represent the original sample composition. A long injection time is usually applied to overcome this bias-injection effect.

Therefore, there is a need for a microfluidic device that provides a fast sample loading technique where the sample composition is uniform at the injection point.

### BRIEF DESCRIPTION

Briefly, according to one embodiment of the invention, a method for injecting a sample during electrophoresis is provided. The method comprises loading a sieving matrix through one end of a separation channel, loading a sample into an injection channel by capillary force, injecting at least a portion of the sample into the separation channel by applying an electro-kinetic force on the sample.

In another embodiment, a microchip for electrophoresis is provided. The microchip comprises a separation channel configured to receive a sieving matrix and a buffer and an injection channel in fluid communication with the separation channel. The injection channel is configured to receive a sample by capillary force and inject a portion of the sample into the separation channel due to an electro-kinetic force exerted on the sample.

### DRAWINGS

These and other features, aspects, and advantages of the present invention will become better understood when the following detailed description is read with reference to the accompanying drawings in which like characters represent like parts throughout the drawings, wherein:

FIG. 1 is a layout design of an embodiment of a microchip implemented in accordance with one aspect of the present technique; and

FIG. 2 is a flow chart illustrating one method by which a sample can be injected into a microchip device;

### DETAILED DESCRIPTION

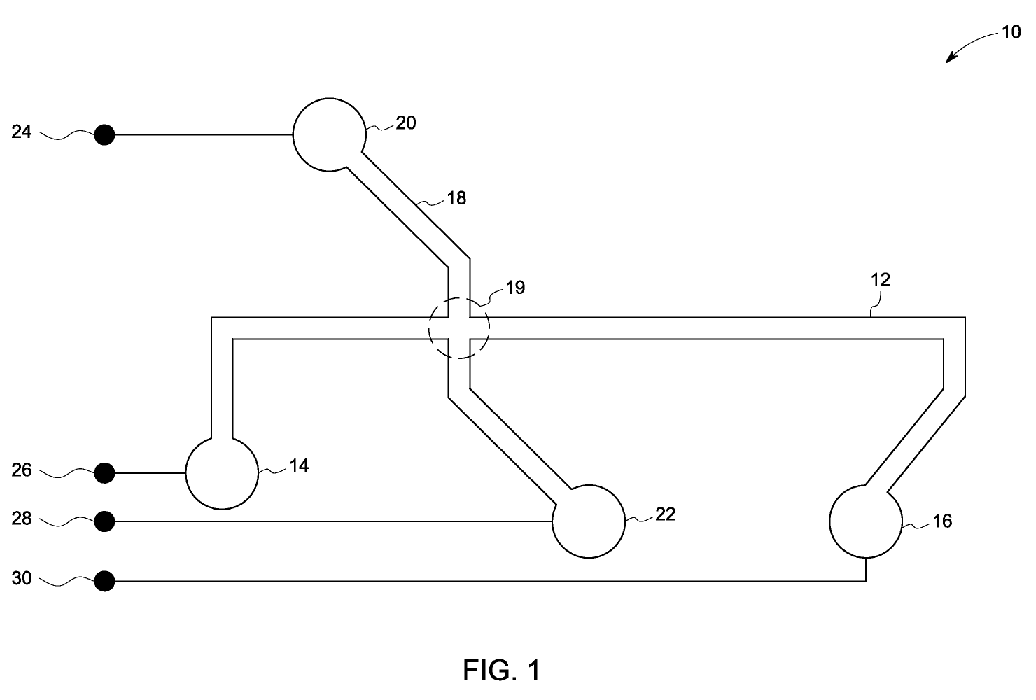

FIG. 1 is a layout design of an embodiment of a microchip implemented in accordance with one aspect of the present technique. Microchip 10 includes separation channel 12 and injection channel 18. Each component is described in further detail below.

Separation channel 12 is an elongated channel including two wells 14 and 16 disposed at its ends. The separation channel is configured to receive a sieving matrix through well 16. Electrodes 26 and 30 extend from the wells 14 and 16 respectively.

Injection channel 18 is in fluid communication with the separation channel. The injection channel comprises two wells 20 and 22. The injection channel is configured to receive a sample by a capillary force. In one embodiment, a surface of the injection channel is modified to enhance the capillary force. In a specific embodiment, the injection channel is filled with a fluid like air, for example, before loading the sample. In one embodiment, the sample is received through well 20 or 22. Electrodes 24 and 28 extend from the wells 20 and 22 respectively.

In one embodiment, the separation channel and the injection channel intersect at a four-way junction as shown by reference numeral 19. In another embodiment, the separation channel and the injection channel intersect at a three-way junction. In another embodiment, the separation channel and the injection channel intersect at two three-way junctions.

The manner in which a sample is injected into the microchip is described in further detail below.

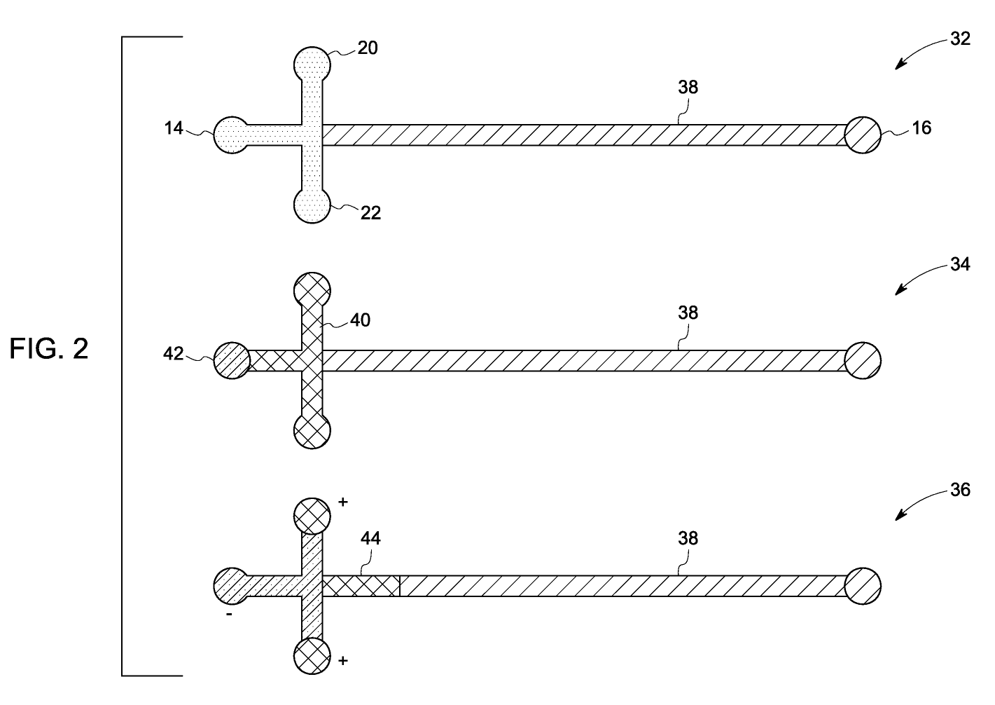

FIG. 2 is a flow chart illustrating one method by which a sample can be injected into a microchip device. The following technique is adapted for use in microchips having the injection channel and the separation channel forming a four-way junction, three-way junction or two three-way junctions. Each step is described in further detail below.

In step 32, a sieving matrix is loaded through one end of a separation channel. In a specific embodiment, the sieving matrix is loaded through well 16 of microchip 10. The sieving matrix occupies a region between four way junction 19 and well 16. In one embodiment, a pre-determined amount of the sieving matrix is loaded into the separation channel. The amount of sieving matrix loaded is controlled by monitoring the separation channel. Due to the capillary force, sample preconcentration and stacking effect at the interface of sieving matrix and the sample is obtained. In one embodiment, a fluidic stop is placed right before the interception of the sample and the sieving matrix to provide definite sample/sieving matrix interface.

In step 34, a sample 40 is loaded into an injection channel. In one embodiment, the sample is loaded through well 20. A buffer is also loaded in the wells 14, 20 and 22. In a specific embodiment, a distance between well 14 and the junction 19 is less than 1 millimeter. In one embodiment, the injection channel is maintained at a pull back voltage.

In step 36, a voltage is applied across the separation channel to further inject the portion of the sample into the separation channel. The voltage depends on a length of the separation channel. In one embodiment, the voltage ranges from 50 V/cm to 1000 V/cm. The pull back voltage is typically about 10-80% of the separation voltage.

In one embodiment, the voltage is applied at electrodes 26 and 30. In another embodiment, the voltage is applied across the separation channel externally. Since the sample is loaded based on a capillary force, the composition of the sample that injects into the separation channel is uniform.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for injecting a sample during electrophoresis, the method comprising:
loading a sieving matrix through one end of a separation channel;
loading a sample into an injection channel by capillary force;
loading a buffer through a second end of the separation channel; and
injecting at least a portion of the sample into the separation channel by the electro-kinetic force exerted on the sample.

2. The method of claim 1, further comprising applying a voltage across the separation channel.

3. The method of claim 1, wherein the separation channel and the injection channel intersect at a four-way junction.

4. The method of claim 1, wherein the separation channel and the injection channel intersect at a three-way junction.

5. The method of claim 1, wherein the separation channel and the injection channel intersect at two three-way junctions.

6. The method of claim 1, wherein loading the sieving matrix comprises loading a predetermined amount of the sieving matrix and wherein the sieving matrix occupies a region after an intersection of the separation channel and the injection channel.

7. The method of claim 6, further comprising, controlling the predetermined amount of the sieving matrix at least in part by monitoring the separation channel.

8. The method of claim 1, further comprising obtaining a sample preconcentration and stacking effect at an interface of sieving matrix and the sample.

9. The method of claim 1, further comprising applying a second voltage on the injection channel to reverse the capillary force on the sample.

10. The method of claim 1, further comprising modifying a portion of a surface of the injection channel to enhance the capillary force.

11. The method of claim 1, further comprising filling the injection channel with a fluid prior to the step of loading the sample.

12. A microfluidic device comprising:
a separation channel configured to receive a sieving matrix and a buffer;
an injection channel in fluid communication with the separation channel; wherein the injection channel is configured to receive a sample by capillary force; wherein a portion of the sample is injected into the separation channel.

13. The device of claim 12, wherein the separation channel and the injection channel intersect at a four-way junction.

14. The device of claim 12, wherein the separation channel and the injection channel intersect at a three-way junction.

15. The device of claim 12, wherein the separation channel and the injection channel intersect at two three-way junctions.

16. The device of claim 12, wherein the separation channel is partially loaded with a desired amount of the sieving matrix.

17. The device of claim 12, wherein the injection channel is maintained at a pull back voltage.

18. The device of claim 12, wherein the separation channel receives the sieving matrix via a well; wherein the well is in fluid connection with the separation channel.

19. The device of 12, wherein the microfluidic device comprises a microfluidic chip.
